(19) United States
(12) Patent Application Publication
(10) Pub. No.: US 2003/0167195 A1
(43) Pub. Date: Sep. 4, 2003

(54) System and method for prioritization of website visitors to provide proactive and selective sales and customer service online

(76) Inventors: Carlos Nicholas Fernandes, Sunnyvale, CA (US); Varsha Arun Jagdale, Singapore (SG)

Correspondence Address: Carlos Nicholas Fernandes, #520, 201 W. Califnoria Avenue, Sunnyvale, CA, 94086, US

(21) Appl. No.: 10/360,926

(22) Filed: Feb. 10, 2003

Related U.S. Application Data
(60) Provisional application No. 60/360,422, filed on Mar. 1, 2002.

(51) Int. Cl. G06F 17/60

(52) U.S. Cl. 705/8

(57) ABSTRACT

A system that (a) monitors and analyzes a website visitor's (or ‘user's’) behavioral patterns in real-time; (b) identifies key users by comparing the user's actions and information derived thereof to a set of pre-defined, merchant-specific business rules; (c) makes a sales and customer service offer to the user only if (1) The user satisfies the merchant's business rules and can therefore be defined as a ‘key’ customer and (2) a suitable sales assistant is online and available to deliver a sales pitch or service assistance to the customer; (d) notifies the available sales assistant only if the customer accepts of the customer service offer and (e) enables communication between the sales assistant and the user through a textual, audio or video interface, (f) improves the appropriateness of allocation of customer service representatives to users, based on user feedback, behavioral patterns and user evaluation.

### CROSS REFERENCE TO RELATED APPLICATIONS

1. U.S. Pat. No 5,991,740

2. U.S. Pat. No. 6,223,215

3. This is non-provisional application corresponding to the provisional patent application No. 60/360,422 filed on Mar. 1, 200 titled “System and Method of prioritization of website visitors to provide proactive and selective sales and customer service online”.

### BACKGROUND OF THE INVENTION

The present invention relates to providing sales and customer service to online customers (customers on a network) in order to increase sales-closures.

While the Internet and wireless web presents massive opportunities in terms of the ability of a merchant/vendor to address a geographically diverse market, it is that very attribute—the Internet's massive reach that prevents it from being a really powerful revenue-generating avenue.

Today, e-commerce on the Internet is essentially a demand-driven vending machine model of doing business. A customer must come in, view a catalog and buy something.

While this model works fine if a customer comes with the intent to purchase a product and is intrinsically familiar with what he is buying, the model fails completely for the sale of complex, high value and high margin products. During the purchase of such products customers are a lot more conservative, resulting in poor online sales for such products.

Only recently have new technologies such as Groopz, enabled proactive (outbound) and vendor-initiated customer service in addition to customer requested service. These technologies are constrained to being used in low volume sites, simply because they require a dedicated sales representative to monitor the website in order to decide which users need to be offered customer service in a proactive manner.

Today, there is no solution that adequately addresses the needs of high volume sites that wish to be proactive in the sale of high margin/cost products. The problem that needs to be solved while catering to these sites is that —while every attempt must be made to provide proactive (Merchant-driven) customer service and sales, it is virtually impossible to proportionally increase the volume of real staff to correspond to the number of simultaneous visitors on a high-volume website that could easily be a few tens of thousands of customers. Another need that is crucial to the success of any online initiative, is the importance of intelligent and timely allocation of appropriate Customer Service Representatives (or alternate service mechanisms) by matching a customer's behavioral patterns to the right Customer Service Representative (or other service agent) at the right time to achieve higher levels of customer service.

In the Business to Consumer space on the Internet, 2% of all website visitors contribute to 100% of the sales, it therefore gains critical importance in environments such as this to accurately identify the top 2% of users and preferably the top 5, or 10% of Web site visitors that can be convinced to buy products online and potentially become paying customers.

In order to correctly identify the best users on a Web site that are most likely to generate sales, or are most needy of customer service we enable a priority-based system wherein Web Site visitors are assigned Quality Points based on their interaction with the Web site. Additionally, a Quality Point mechanism is also associated with CSRs to enable more appropriate allocation to users.

### BRIEF SUMMARY OF THE INVENTION

The present invention is directed to a system that (a) monitors and analyzes a website visitor's (or ‘user's’) behavioral patterns in real-time; (b) identifies key¹ users by comparing the user's actions (and information derived thereof) to a set of pre-defined, merchant-specific business rules; (c) makes a sales and customer service offer to the user only if (1) The user satisfies the merchant's business rules and can therefore be defined as a ‘key’ customer and (2) a suitable customer service representative (real or virtual) is online and available to deliver a sales pitch or service assistance to the customer; (d) notifies the available customer service representative only if the customer accepts the customer service offer and (e) enables communication between the customer service representative and the user through a textual, audio or video interface. ¹Key Visitors—Important, serious, likely or high-priority visitors.

Such a system satisfies the need to be able to selectively use resources including but not limited to manpower and hardware (memory, processor time) on ‘faceless’ customers on the web, thereby focusing on customers that are more likely to buy or provide other monetary or non-monetary benefits to the merchant than others.

### BRIEF DESCRIPTION OF THE SEVERAL VIEWS OF THE DRAWING

FIG. 1 Diagram of a computer system(s) on which the invention may be deployed and/or implemented.

FIG. 2 Flow Diagram for information flow that describes in general functioning of the entire system.

FIG. 3 Flow Diagram describing the functioning of the User Point Allocation subsystem.

FIG. 4 Flow Diagram describing the functioning of the CSR Allocation subsystem.

FIG. 5 Block Diagram of the entire system.

### DETAILED DESCRIPTION OF THE INVENTION

“Web site” is used to refer to a user-accessible network site that implements World Wide Web standards for coding and transmission of hypertextual documents such as HTML (Hypertext Markup Language) and HTTP (Hypertext Transfer Protocol). Sites built with non-HTML markup or code such as VoiceXML, WML are also called “Web sites”, the only difference being that they relate to the “Wireless Web”. The term “site” is not intended to imply a single geographic location, as a Web or other network can, for example include multiple geographically distributed systems that are appropriately linked together.

“User”, “Web Site visitor” refer to a person who is using and/or interacting with a Web site.

“Merchant” refers to the individual or company that is utilizing the Internet to do business. In the preferred embodiment, it refers to the owner of a Web site that may or may not allow for online transactions.

“Key visitor(s)” refer to user(s) that are more likely than others to improve business for the Merchant. In the preferred embodiment, it refers to users that are more likely to buy products/services from the Merchant and those that represent a manageable quantity of users that can be served by the number of appropriately skilled sales/service representatives that are available.

“Deploying team” includes the Merchant and also refers to the people (employee(s), consultant(s), or other personnel) that are deploying and customizing the invention in the Merchant's best interest. The deploying team (or any members thereof) has a solid understanding of the merchant's business so as to suitably configure the business rules (that drive the invention) for the Merchant.

“Data Repository” includes databases (relational, object-oriented, hierarchical or otherwise) and any other data structures or data storage mechanisms.

“CSR” refers to customer service representatives, sales agents, or any personnel that are involved in marketing, promoting, selling products/services or serving users and customers. “CSRs” may also include ‘Servabots’ or programs that simulate a real, human CSR.

“CSR Client Interface” is the client-side component of the technology that is run by the CSRs on their computers that forms a subsystem of the invention that is used by the CSRs to communicate and service users.

“Quality Points” are points assigned to a user by the present invention based on users actions, the Web page on which those actions are occurring, previously performed actions, attributes of the user and Merchant-defined business rules.

“Quality Score” refers to the total Quality Points associated with a user.

“Idle” when used in reference to a user refers to the state of a user that has clicked and loaded a Web page but is not interacting with it. This may be gauged by the absence of any clicks on a page, or lack of mouse movement.

“Web browser” refers to technology (typically software) that is used to view and/or “experience” sites on the Internet. The terms “experience” is used since some sites may not be “seen” but may be “heard” if they are built with technologies for the wireless web such as VoiceXML.

“Servabots” are NLP (Natural Language Processing) programs or AI (artificial intelligence) code that may be used to simulate the conversational, sales and recommendation patterns of a real, human CSR. It is anticipated that Servabots will work in tandem with real CSRs to serve users online.

The present invention is directed to a system for identifying and selectively serving and/or marketing by constraining the use of resources to a small set of key Web Site visitors from a potentially large group of users based on a customer prioritization mechanism. The system operates by monitoring user interaction with the Web Site and correspondingly assigns users with ‘Quality Points’. The Quality Points associated a user, the number of online users and the number of appropriately skilled CSRs is used to determine (1) If a user receives an offer of customer service (2) What type and quality of service he receives if he accepts the service offer.

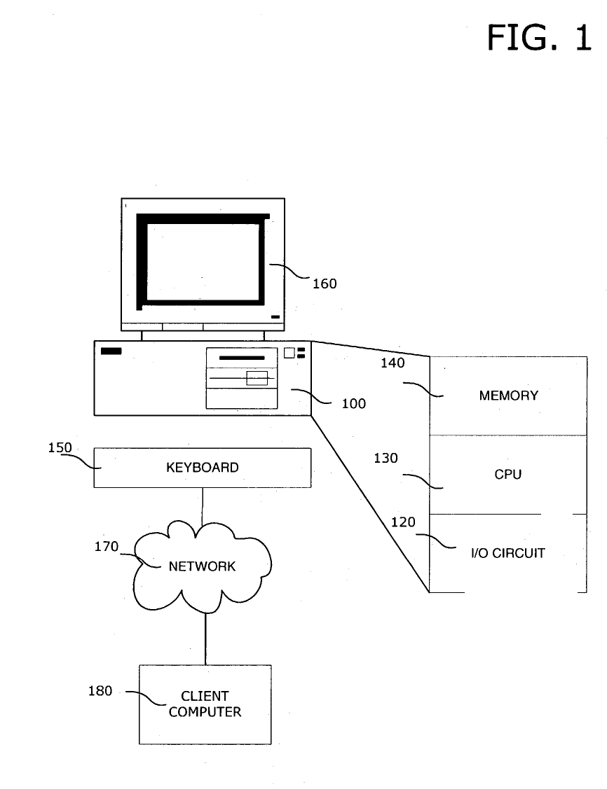

FIG. 1 illustrates a data processing system in accordance with one embodiment of the present invention. FIG. 1 shows a computer 100, which includes three major elements. Computer 100 includes an input/output (I/O) circuit 120, which is used to communicate information in appropriately structured form to and from other portions of computer 100 and other devices or networks external to computer 100. Computer 100 includes a central processing unit (CPU) 130 (e.g., a microprocessor) in communication with I/O circuit 120 and a memory 140 (e.g., volatile and nonvolatile memory). These elements are those typically found in most general-purpose computers and, in fact, computer 100 is intended to be representative of a broad category of data processing devices.

A raster display monitor 160 is shown in communication with I/O circuit 120 and issued to display images generated by CPU 130. Any well-known variety of cathode ray tube (CRT) or other type of display can be used as display 160. A conventional keyboard 150 is also shown in communication with I/O circuit 120. FIG. 1 would include handheld computers and other wireless devices.

It will be appreciated by one of ordinary skill in the art that computer 100 can be part of a larger system. For example, computer 100 can be a server computer that is in data communication with other computers. As illustrated in FIG. 1, computer 100 is in data communication with a client computer 180 via a network 170, such as a local area network (LAN) or the Internet.

In particular, computer 100 can include user prioritization software to identify key users of the Web site in accordance with teachings of the present invention. In one embodiment, as will be appreciated by one of ordinary skill in the art, the present invention can be implemented in software executed by computer 100, which is a server computer in data communication with client computer 180 via network 170 (e.g., the software can be stored in memory 140 and executed on CPU 130), as further discussed below.

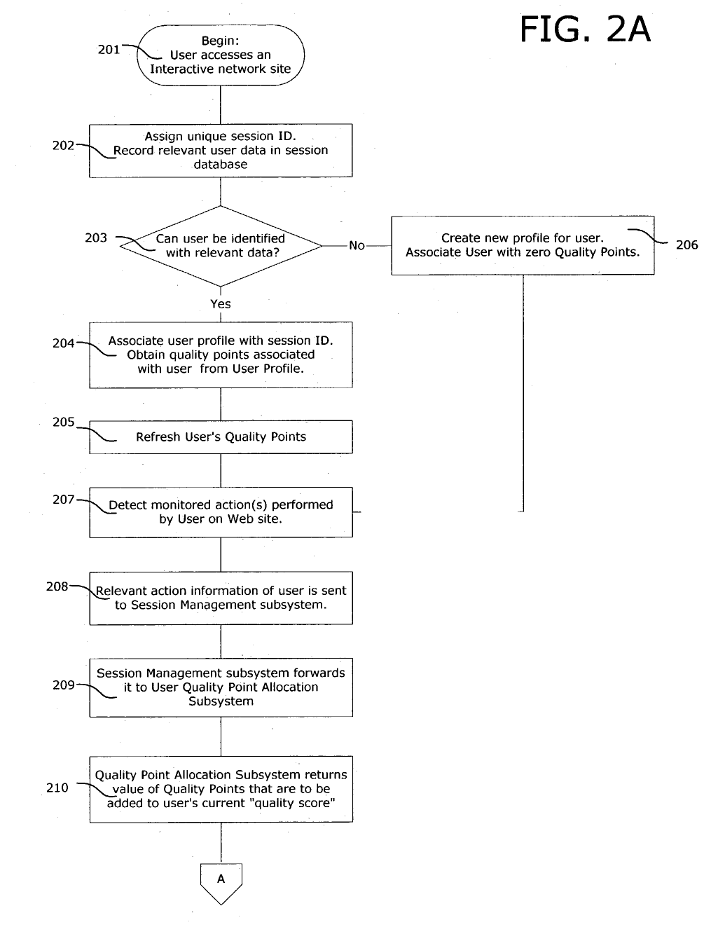

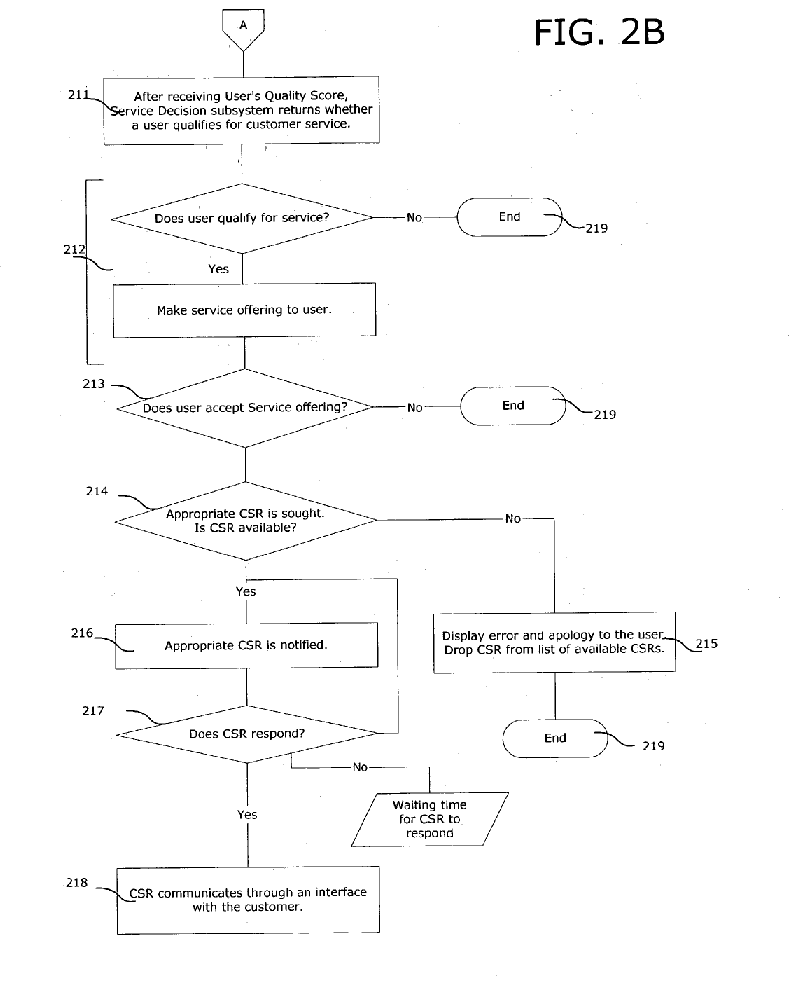

FIG. 2 is a flow diagram of user prioritization with one embodiment of the present invention. Operation begins at stage 202 in response to a new user initiating access (for example, accessing a website) to an interactive network site. At stage 202, a unique session ID (identifier) is assigned from a front-end session database, and relevant user data is recorded in the session database associated with the session ID. For example, the relevant user data includes the user's inbound source (origin), such as a unique source ID of a banner (advertisement) on a search engine WWW site (e.g., which can be determined using standard name-value pairs passed via HTTP protocol).

In stage 203, an attempt is made to identify the user by using the relevant information obtained in stage 202 using techniques familiar to one of ordinary skill in the art (e.g. login identifier, cookies, Internet Protocol (IP) address, etc.). In the preferred embodiment, the cookie identifier is used as a primary key to the User Profile Database to obtain the profile of the user, if available.

In stage 204, if a user profile is found, it is associated with the session id. The user profile contains the Quality Points associated with the user based on his interactions with the Web site on previous occasions. The method of allocation of Quality Points is further discussed in the section “ALLOCATION OF QUALITY POINTS FOR A USER”. Other embodiments may include the association of the session ID with a “Macro Profile”. A Macro Profile is not associated with a single user but is associated with many users based on statistical models that correspond to the users of a particular demographic. For example, the users from a particular origin, as obtained in stage 202 may be assigned a macro profile to complement or compensate for the absence of a user profile.

In stage 205 the user's Quality Points are refreshed. “Refreshed” refers to the adjusted value of the Quality Points associated with the customer at the beginning of the new session based on Quality Points the user has obtained in previous sessions. The method of adjustment of priority points is discussed in the section “OBTAINING INITIAL QUALITY POINTS FOR A REPEAT USER”.

Stage 206 occurs when there is no user profile associated with a user. The system interprets the absence of any profile as an indication of a first-time user. The front-end session database then creates a new profile for the user and the user is associated with the appropriate Quality Points.

In stage 207, the user performs an action on the Web site. These actions include all actions that can be monitored on the user interface such as mouse movements mouse activity and inactivity, clicks on images, buttons or links, or hesitation on a particular web page or field in the form filling process. A variety of client side event-monitoring technologies such as JavaScript can be used to detect user actions.

In stage 208, the relevant action information of the user is sent to the Session Management subsystem. The relevant action information includes the action name and the parameters associated with the action name. One with ordinary skill in the art will potentially use a lava Applet and Java networking APIs to post the event information it receives via a JavaScript-Java communication mechanism to the Session Management subsystem in a manner that is transparent to the user and does not necessitate page reloads on the user interface, which is a web browser in the current embodiment.

Stages 207 and 208 refer to specific technologies that are not intended to be representative of the only technologies that can be used. There may be other mechanisms to achieve the abovementioned stages.

In stage 209, the Session Management subsystem receives the relevant action information and submits it to the User Quality Point Allocation subsystem.

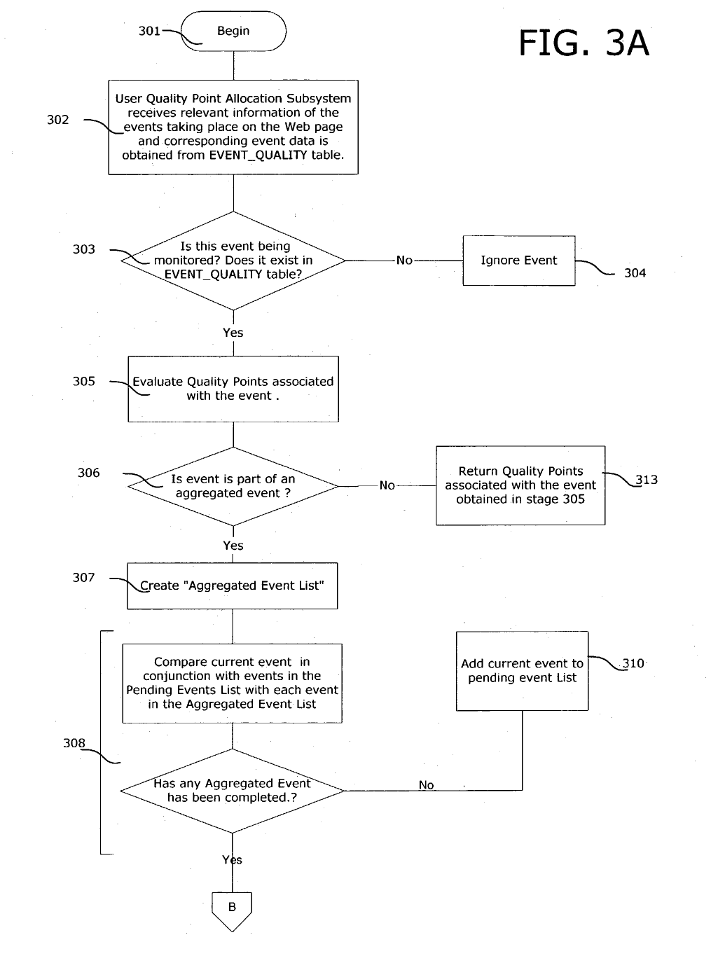

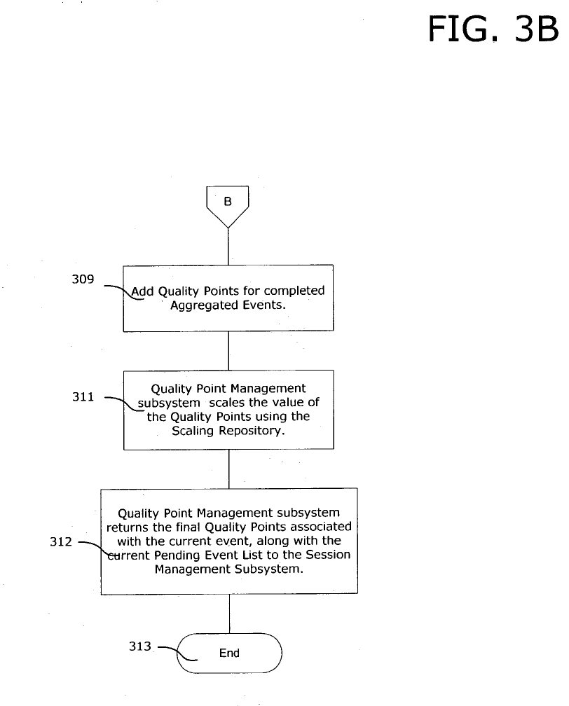

In stage 210, the User Quality Point Allocation subsystem responds by returning the value of the corresponding Quality Points that are to be added to the user's current “quality score” (Total Quality Points obtained by user) based on the user's action(s) along with other relevant information. Stage 210 is further discussed below with respect to FIG. 3.

In stage 211, the Session Management subsystem forwards the user's quality score to the CSR Allocation subsystem. The CSR Allocation subsystem uses the user's quality score, and the CSR availability information to determine whether a user qualifies for customer service and/or sales effort and if so, the type and quality of service that the user qualifies for. The decision of what type of service the user qualifies for, involves deciding whether the user is served by a Servabot, a CSR, or receives a guided and shared experience with a CSR or any other type of customer service. This information is delivered back to the Session Management system. Stages 207-211 continue to occur in the background as the user uses the site.

Stage 212 occurs when the user qualifies for customer service and a service offering is made to the customer in accordance with the instructions from the CSR Allocation subsystem. Stage 212 is expressed in greater detail in the section “DETERMINATION OF WHETHER A CUSTOMER QUALIFIES FOR SERVICE”.

Stage 213 occurs when the user clicks on the Service Offering to indicate acceptance of the service offer. At this point, the chat window opens and a message appears in the window indicating that a suitable CSR is being sought. The CSR Allocation subsystem is notified of the user's acceptance and also receives the user profile information from the Session Management subsystem.

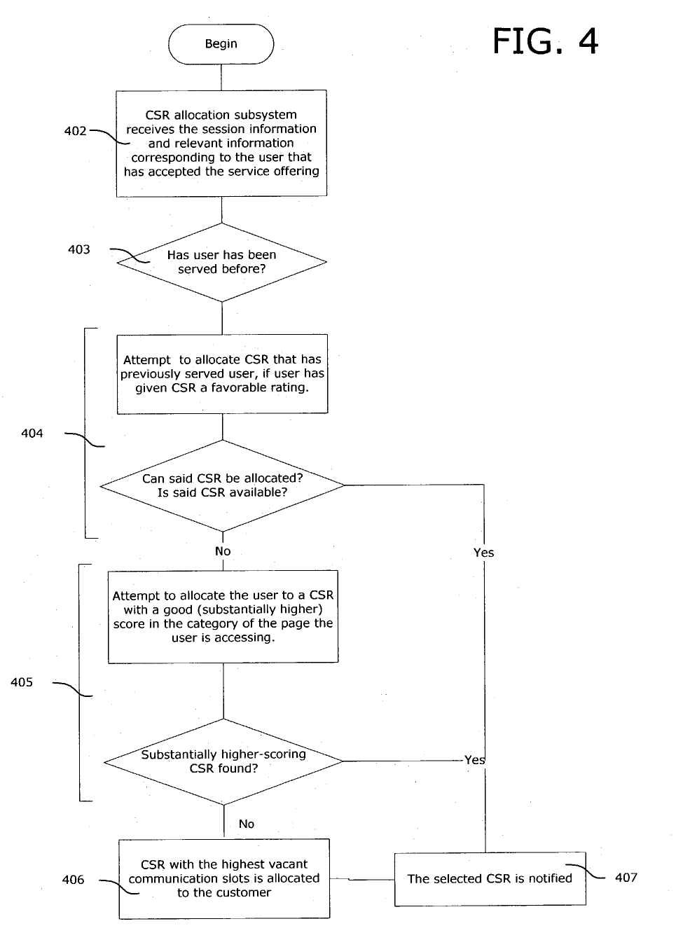

In stage 214, the CSR Allocation subsystem that maintains a list of all available CSRs and their attributes, skills and ratings attempts to associate user to the appropriate CSR, from the pool of available CSRs. Stage 214 is further discussed below with respect to FIG. 4.

In the event that there is no CSR available, (This means that a CSR was available at the time the service offer was made, but by the time the user accepted the service offer, the CSR was no longer available) Stage 215 occurs and an error, apology or explanation are delivered to the user. In order to prevent stage 215 from occurring it is recommended that the service offering that may potentially appear as a floating image across the screen disappears after a pre-defined period of time or when the unavailability of the CSR is detected.

In stage 216, the appropriate CSR is notified through an audio or visual interface on her computer.

In stage 217, the CSR Allocation subsystem waits for the CSR to respond within a configurable amount of time (e.g. 30 seconds). Once the CSR responds, a chat window opens and the CSR can communicate through the interface with the customer. At this point the CSR client subsystem verifies the CSRs availability and notifies the CSR Allocation subsystem if the CSR is no longer available. Accordingly, the CSR Allocation subsystem drops the CSR from the list of available CSRs. In the preferred embodiment of the invention, the communication will be through a textual interface that uses the Session Management system as a proxy that routes the text to the user. The text entered in the user's chat window is sent to the Session Management subsystem via the client-side Javascript and Java and then routed to the appropriate CSR.

In stage 218, once the CSR is notified the chat with the user ensues. Stage 219 occurs, if at any point a user does not qualify for service, has opted out or is unable to be associated with an appropriate CSR.

The actual mechanism for transferring textual, event and other information from the user to the CSR as well as enabling a two-way communication between the user and the CSR will be clearly apparent to one with ordinary skill in the art. In the preferred embodiment, JavaScript monitors textual (chat) and events on the user interface (the browser) and the routing from the browser to the server-side (Session Management subsystem) part of the system (and vice-versa) are handled with Java Applets. Internally, on the server-side part of the system different subsystems may be implemented as multiple modules that communicate using protocols such as HTTP, RMI or socket communications. In the preferred embodiment, the all the subsystems are implemented as a single application containing multiple classes.

Allocation of Quality Points For a User

FIG. 3 is an exploded flow diagram of stage 210 (FIG. 2). In stage 302, the User Quality Point Allocation Subsystem receives relevant information in terms of the events taking place on the Web page (e.g. User has added a product to the shopping cart, User is idle) that the user is interacting with, details of the Web page that the user is accessing (e.g. “Page Priority ID”, “Page Category”) from the Session Management subsystem. In addition the Session Management subsystem sends the “pending” event information to the User Quality Point Allocation subsystem. Events that compose sequences of multiple events are termed as “composite events”. “Pending events” are those events that may compose a composite event. The session subsystem therefore caches to create a composite event. In order to prevent excess memory requirements and excess network traffic that may result due to storing and transferring of many pending composite events, one embodiment will associate each event with a date-stamp that will be used to determine when the pending composite information needs to be abandoned. The Session Management subsystem may be configured with a “keep-alive-time” for all pending composite events, after which all pending composite events.

The example below illustrates the importance and reasons behind having “composite events”.

An event with EVENT_NAME =IDLE_TIME_ON_WEB_PAGE (EVENT_NAME is the field that contains the name of the event) may not be monitored on it's own, but may be monitored only if an event with EVENT_NAME=CHECK_OUT_SHOPPING_CART has just occurred. While it may be prohibitively expensive to offer service to every user that is “idle” on the Web page and therefore results in no Quality Points being associated with the IDLE_TIME_ON_WEB_PAGE event, it may be important to serve a user if the user has just clicked the “check out” button and then stops interacting with the Web site. The two events, CHECK_OUT_SHOPPING_CART and IDLE_TIME_ON_WEB_PAGE occurring in sequence gain importance (and are therefore associated with Quality Points) since it clearly indicates that a user intended to buy product(s)/service(s) from the Web site but did not complete the transaction.

Before discussing stage 303 it is important to discuss the structure of the User Quality Point Allocation subsystem that includes a “Quality Point Allocation database” and a “scaling repository”.

Quality Point Allocation Database

Quality Point Allocation database allows the mapping of user actions and events to Quality Points. In one embodiment, the Quality Point Allocation database would be a table, EVENT_QUALITY within the quality point allocation database that contains the fields, “EVENT_ID”, “EVENT_NAME”, “PART_OF_COMPOSITE_EVENT_FLAG”, “IS_COMPOSITE_EVENT”, “COMPOSITE_EVENT_DESC”, “QUALITY_POINTS_TYPE”, “QUALITY_POINTS”, “ADJUSTMENT_TYPE”, “ADJUSTMENT PERIOD” and “ADJUSTMENT_FACTOR”.

Both EVENT_ID and EVENT_NAME would function as primary keys to the EVENT_QUALITY table. The benefit of having two primary keys is such that since each record can be accessed either field, it is possible for the client-side JavaScript to transfer from the client to the server-side part of the system only the EVENT_ID as against the EVENT_NAME that would increase network traffic. In other embodiments, only one of the two fields, EVENT_ID and EVENT_NAME may be used.

PART_OF_COMPOSITE_EVENT_FLAG (Boolean datatype) indicates if a particular action/event is part of a larger sequence of simple events (composite events) that is being monitored. IS_COMPOSITE_EVENT_FLAG (Boolean datatype) wherein “TRUE” indicates the action itself represents a sequence of other events and is therefore defined is a composite event. “FALSE” indicates that the event is not a composite event but may (PART_OF_COMPOSITE_EVENT_FLAG=TRUE) or may not be a part of a composite event (PART_OF_COMPOSITE_EVENT_FLAG=FALSE).

If the IS_COMPOSITE_EVENT_FLAG is “TRUE” the COMPOSITE_EVENT_DESC field contains delimited EVENT_ID (s) of actions that compose the composite action in the correct order in which they need to occur (in the case of ordered composite events). If the IS_COMPOSITE_EVENT_FLAG is “FALSE” the COMPOSITE_EVENT_DESC field contains delimited EVENT_ID (s) of the composite actions that the action is a part of.

For a simple event, the IS_COMPOSITE_EVENT_FLAG is “FALSE”, but the PART_OF_COMPOSITE_EVENT_FLAG may or may not be true. An example of a simple event would be a mouse click on an “Add to shopping cart” button or one on a “Frequently asked Questions” button. An example of an aggregated event would be a click on an “Add to shopping cart” button followed by a click on a “Frequently asked Questions” button.

“QUALITY_POINTS_TYPE” is of integer (or “number”) datatype that may have values 1, 2 or 3 and helps define how the QUALITY_POINTS field needs to be interpreted. QUALITY_POINTS would be of a “varchar datatype” and will store either the Quality Points associated with the particular event directly (QUALITY_POINTS_TYPE=1) or store “rules” that can be used to generate the Quality Points associated with the event. The “rules” may be a function (QUALITY_POINTS_TYPE=2) that uses the parameters associated with an event to evaluate the Quality Points or simply be a reference to a class, method or third party program (QUALITY_POINTS_TYPE=3) that can evaluate the Quality Points associated with the action.

For example, If QUALITY_POINTS_TYPE=1 and QUALITY_POINTS=“3” the system will recognize that there are three Quality Points directly allocated for that particular event.

In another scenario, QUALITY_POINTS_TYPE=2 and QUALITY_POINTS field may contain “t*2”. In this case, t will also be a parameter associated with the corresponding action (In this case an action where, EVENT_NAME=IDLE_TIME_ON_WEB_PAGE). This Action may have 2 parameters associated with it such as u (URL of the Web Page) and t (time on the Web Page). Thus if a user spends, say, 20 seconds idle time on a Web Page, an event is generated that passes the parameters u and t to the User Quality Point Allocation subsystem to associate 20*2=40 Quality Points for the event as specified in the QUALITY_POINTS field for the event.

In a third scenario, the method for allocating Quality Points is even more complex. Different rules may be needed to evaluate the associated Quality Points for different ranges of variables. For example, while still referring to the action, IDLE_TIME_ON_WEB_PAGE the rule may be such that

if (t<20) QUALITY_POINTS=t;

else

QUALITY_POINTS=t*2;

In a scenario such as the above, where QUALITY_POINTS_TYPE=3, the QUALITY_POINTS field will contain a reference to another class, method, function or program to evaluate in the Quality Points associated with that action. The format of the function would be ClassName: MethodName(param1, param2 . . . ) or any other mechanism that can be used to accurately locate the appropriate code that can generate the Quality Points for that action. The Quality Points as allocated above are the “raw” Quality Points, simply because these Quality Points are allocated only on the basis of events and user profiles, but are not associated with the page(s) from which these events are originating. More details in this regard are mentioned below in the “Scaling Repository” section.

It is important to note, as one of ordinary skill in the art will be aware of, that one needs to provide the appropriate JavaScript on the HTML that monitors such client-side events to register these events with the appropriate EVENT_NAME and parameters so that the Quality Point Allocation subsystem is able to recognize such events and correspondingly add the appropriate number of Quality Points to the user's profile.

“ADJUSTMENT_TYPE”, “ADJUSTMENT_PERIOD” and “ADJUSTMENT_FACTOR” are fields used to evaluate the Quality Points assigned to a repeat visitor in the beginning of a new session with respect to the Quality Points obtained in previous sessions. A detailed description of the fields is specified in the OBTAINING INITIAL QUALITY POINTS FOR A REPEAT USER section.

Scaling Repository

The main function of the Scaling Repository is to provide “weights” to scale up or scale down the value of the “raw” Quality Points as obtained from the Quality Point Allocation database. The principle behind this is that the same event occurring on different pages of a Web site may have different Quality Points associated with it. For example, the Merchant may attach greater importance (and therefore more priority points) to a shopping cart being abandoned on the “Electronics” section of the site than if the shopping cart is abandoned on the “Books” section of the site. Thus, while the Quality Point Allocation database specifies Quality Points based on “Which” event occurs, the Scaling repository specifies the “adjustment” of the Quality Points based on “Where the event occurs”.

The User Quality Point Allocation system uses the “weights” specified to scale the Quality Points obtained by a user based on the priority ID of the Web page as specified in the HTML of the Web page.

In the preferred embodiment every Web Page created is attached with a suitable priority ID that is sent along with the other relevant information to the Quality Point allocation subsystem. The Scaling repository consists of a table SCALE_TABLE that has the fields, PRIORITY_ID (Primary Key), SCALE_TYPE, SCALE_FACTOR. SCALE_TYPE will be of a “number datatype” and contain an Integer 0 or 1. SCALE_TYPE=0 will indicate that the scale factor needs to be used “as is” and needs to be multiplied with the raw Quality Points from the Quality Point Allocation database. SCALE_TYPE=1 indicates that SCALE_FACTOR specifies a class and corresponding method that may be used to calculate the scale factor. The use of SCALE_TYPE=1 is atypical.

For example, Let us consider a page on which the event(s) have occurred has a priority ID of 1 and, the raw Quality Points as delivered by the Quality Point Allocation database are 100. If a snapshot of the SCALE_TABLE is as below,

SCALE_TABLE

| PRIORITY_ID | SCALE_TYPE | SCALE_FACTOR |
|---|---|---|
| 1 | 0 | 0.5 |
| 2 | 1 | ClassName.MethodName() |

Then, the value of the scale priority points is 100*0.5=50.

In stage 303, it is verified if the name of the event (current event) that has occurred exists in the EVENT_NAME field in the EVENT_QUALITY table. If the event exists, it indicates that this is an event that is monitored by the Merchant and information present in the corresponding row is accessed.

Stage 304 occurs if the event does not exist in the EVENT_QUALITY table indicating that the event must be ignored. The Session Management system is notified of the Quality Points associated with the event to be zero.

In Stage 305, the QUALITY_POINTS_TYPE and QUALITY_POINTS are used to evaluate the Quality Points associated with the current event. These Quality Points are the points associated with the individual, current event only. If the current event is an event that forms part of a composite event, it is possible that the Quality Points associated with the individual event (on its own merits) may be zero. Nevertheless, the Merchant is free to configure the system wherein a single event may have Quality Points associated with it by virtue of the event itself, as well as have Quality Points associated with it by virtue of completing a composite event.

In stage 306 it is verified if the event is part of a composite event by checking the PART_OF_COMPOSITE_EVENT_FLAG field in the EVENT_QUALITY table. Stage 313 occurs if the current event is not part of a composite event, resulting in returning the Quality Points to the Session Management subsystem as obtained in stage 305.

If the event is part of a composite event, an “Composite Event List” is created in stage 307. The Composite Event List contains the uniquely identifiable event name(s) of the composite event(s) of which the current event may be a part. These are obtained by parsing the COMPOSITE_EVENT_DESC field in the EVENT_QUALITY table in the context of the current event.

In stage 308, the current event, in conjunction with the Pending Events (as listed in the pending event list) is compared with each event in the Composite Event List. Stage 308 is further discussed below with respect to the section TYPES OF COMPOSITE EVENTS.

Stage 309 occurs if it is identified that by virtue of the current event, a composite event has been completed. The Quality Points are added accordingly for each completed composite event. The pending events that also contributed to the completion of the composite event are dropped from the Pending Event List.

If stage 309 does not occur, it signifies that the current event has not contributed to the completion of any composite event and the current event is added to the Pending Event List in stage 310 and no Quality Points are added.

In stage 311 the Quality Point Management subsystem uses the Scaling Repository to scale the value of the Quality Points based on the page the customer is viewing, the content or the page priority as discussed in earlier.

In stage 312, the Quality Point Management subsystem returns the final Quality Points associated with the current event, along with the current Pending Event List to the Session Management Subsystem.

The above embodiment refers to “events” that are spawned by a user. However, it will be clear to one with ordinary skill in the art that just as the current embodiment is not limited to a fixed type and number of events, it is also not limited to only allocating Quality Points for events, but also for “user profiles”. A Merchant, for instance may create a table similar to EVENT_QUALITY called “PROFILE_QUALITY” wherein certain attributes of a user are mapped with certain Quality Points. The PROFILE_QUALITY table will have a field QUALITY_POINTS (Similar to the Quality Points field in EVENT_QUALITY table) that will either store or be used to evaluate Quality Points for a user based a particular aspect of his profile. For example, a PROFILE_NAME (similar to EVENT_NAME) such as USER_AGE may be allocated Quality Points equal to two times the user's age. Other evaluating mechanisms could be used depending on the QUALITY_POINTS_TYPE and QUALITY_POINTS.

Obtaining Initial Quality Points for a Repeat User

At the end of every session a user's profile is stored (or updated) in a database or any other form of persistent storage known as the user profile Quality Point Allocation database. The repository also stores the value of the user's Quality Score at the end of the session. The user profile database includes other relevant information such as the user's previous actions, interests and registration information (if any).

While a user's relevant historical information (e.g. previous events, actions and profile information) need to be considered, a Merchant may not want a user's previously obtained Quality Points to undermine or overshadow the value of Quality Points obtained in the current session. The invention allows a Merchant to specify an “adjustment factor” for Quality Points that are based on relevant historical user information. After the previously obtained Quality Points (over previous sessions) are “adjusted” to render the new value of the Quality Points associated with the user (at the beginning of the new session), the user's Quality Points are said to be refreshed.

In order to suitably adjust the previously obtained Quality Points, the ADJUSTMENT_TYPE, ADJUSTMENT_PERIOD and ADJUSTMENT_FACTOR fields in the QUALITY_POINT_ADJUSTMENT table are used. The ADJUSTMENT_TYPE field is of integer (or “number”) datatype may have values 1 or 2 and helps define how the ADJUSTMENT_FACTOR field needs to be interpreted. ADJUSTMENT_FACTOR would be of a “varchar datatype” and will store either the factor by which the Quality Points need to be multiplied with directly (ADJUSTMENT_TYPE=1) or store a reference to a class, method or third party program (ADJUSTMENT_TYPE=2) that accepts the current Quality Points and the last modified date (date and time of ending of last session) to return the new, refreshed value of the priority points. ADJUSTMENT_PERIOD field is valid only when ADJUSTMENT_TYPE=1. It is used to evaluate the number of times the ADJUSTMENT_FACTOR needs to be multiplied with the last associated Quality Points to calculate the initial number of Quality Points in the new session.

A snapshot of a sample QUALITY_POINT_ADJUSTMENT table demonstrates how the ADJUSTMENT_TYPE, ADJUSTMENT_PERIOD and ADJUSTMENT_FACTOR affect the allocation of initial Quality Points for a previous visitor.

QUALITY_POINT_ADJUSTMENT TABLE

| | ADJUST- | |
|---|---|---|
| ADJUSTMENT_TYPE | MENT_PERIOD | ADJUSTMENT_FACTOR |
| 1 | 1 | 0.1 |

If a Merchant chooses a 0.10 ADJUSTMENT_FACTOR (decay) per day of Quality Points when no sessions have been recorded,

CSS_{—}QP=Current Starting Session Quality Points.

PES_{—}QP=Previous Ending Session Quality Points.

N=Number of intermediate days where no sessions are recorded.

Then,

CSS_{—}QP=PES_{—}QP*0.1*N

Thus, CSS_QP represents the refreshed (and in this case, reduced) value of the Quality Points associated with the customer at the start of the new session.

In the example below we illustrate how the Quality Points associated with a user may decay with time.

Session 1 on Date May 11, 2001

Total Quality Points at the end of the session 1: 60

Session 2 on Date May 13, 2001

Previous total Quality Points: 60

Decay of Quality Points (@0.1*PES_QP per day): 60*0.1 (for 1 day of no usage)=6

Starting Quality Points at the beginning of session 2: 60−6=54

Quality Points gained in Visit 2: 35

Total Number of Quality Points at the end of session 2: 35+54=89

Session 3 on Date May 17, 2001

Previous total Quality Points: 89

Decay of Quality Points (@0.1* PES_QP per day): 89*0.1*3 (for 3 days of no usage)=26.7=27 (After rounding off)

Starting Quality Points at the beginning of session 3: 89−27=62

In another embodiment, a separate ADJUSTMENT_TABLE may not be used, but the ADJUSTMENT_TYPE, ADJUSTMENT_PERIOD and ADJUSTMENT_FACTOR fields may be added to the EVENT_QUALITY table and each ADJUSTMENT_FACTOR would correspond to different events. This would enable a more fine-grained approach that would allow Quality Points to be adjusted for different events with different factors, rather than adjusting the final Quality Points in a previous session directly to obtain the Quality Points in the next session.

If QP1, QP2, QP3 represent Quality Points obtained in previous sessions for different events/actions.

Previous ending Session Quality Points, PES_QP=QP1+QP2+QP3 . . .

If AQP1, AQP2, AQP3 represent adjusted values of QP1, QP2 and QP3 respectively and AQP1<QP1 and so on.

Current Starting Session Quality Points, CSS_QP=AQP1+AQP2 +AQP3 . . .

AQP1=f(QP1) as defined by the merchant.

At the end of stage 205 (FIG. 2), after using any of the adjustment mechanisms specified above or by using 3^{rd} party programs or classes to calculate adjusted values of Quality Points, the user is associated with a refreshed value of Quality Points at the beginning of his usage session.

Determination of Whether a Customer Qualifies for Service

The decision of whether a user qualifies for a service offering depends on two factors: The availability of online CSRs and/or other online resources as well as the Quality Points associated with each user. This decision is made by the CSR Allocation subsystem.

The CSR Allocation engine accepts connections from the CSR Client Interface and maintains a “CSR List” that includes all CSRs connected to the system and their corresponding “status”. As one with ordinary skill in the art would be aware, this is possible using a variety of both stateless and stateful protocols and communication techniques. Additionally the CSR status subsystem accesses a CSR repository containing CSR information.

The CSR Client Interface runs on each CSRs computer. This client-side technology monitors mouse usage, key-press events and applications currently open and/or being used, as discussed in the “CSR STATUS MONITORING” section. The technology automatically maintains the status of the CSR based on the CSRs usage patterns. This CSR status information is fed to the CSR Allocation engine that maintains the status information with regard to which CSRs are busy, which are available and to how many more users each CSR can communicate with (vacant communication slots).

To illustrate this, consider a CSR Allocation engine with three CSRs connected to it.

| CSR Name (or ID) | Availability | Vacant Communication Slots |
|---|---|---|
| Jack | No | 0 |
| John | Yes | 3 |
| Amy | Yes | 2 |

The information above is stored in Memory of the CSR Allocation subsystem. This information may be stored in a variety of data structures leveraging arrays, vectors and object oriented techniques, as one with ordinary skill in the art will be aware of. “CSR Name” is used to uniquely identify a CSR. CSR information regarding skill sets, abilities and other relevant information will be stored in a CSR profile database so that the CSRs are appropriately matched to the right customers.

At this point there are 0+3+2=5 vacant communication slots, hence service offers are made to users with the five highest Quality Points. The Session Management system is notified of which users need to be made service offers. If the number of users is less than the total number of vacant communication slots, all users are offered service.

In one embodiment, to prevent the possibility of a service offering being made whose corresponding acceptance cannot be fulfilled (Since the CSR is no longer available) the number of sales offers may be less than the number of vacant communication slots.

It is also possible that for a particular Web site and the user demographic profile accessing the site, only 1 out of every 5 service offers are accepted. In an embodiment to accommodate for this scenario, the number of sales offers may exceed (in this case 5 times) the number of vacant communication slots so that the CSRs are well utilized.

FIG. 4 is the flow diagram that demonstrates the process of appropriately associating a CSR with a user after the service offer has already been made and accepted by the CSR. It is an exploded view of stage 214 (FIG. 2). In stage 402, the CSR allocation subsystem receives the session information and other relevant information corresponding to the user that has accepted the service offering.

In stage 403, the CSR Allocation subsystem verifies if the user has been served before. In the event the user had been served before and has offered a “favorable” rating to the CSR during his last interaction, an attempt is made (provided that CSR is with status “available”) to allocate the CSR that previously served the user in stage 404.

The relevant information received by the CSR Allocation subsystem includes page category and content information. This information, like page priority, is associated with the Web page. In stage 405 an attempt is made to allocate the user to a CSR with a substantially higher score in the given category.

If stage 405 is not successful in terms of finding an “outright winner” CSR, but there are a few CSRs with reasonably good ratings that do not differ from each other significantly, stage 406 occurs wherein a CSR is selected from the list obtained in stage 405 based on which CSR has the highest vacant communication slots.

In stage 407, the selected CSR is notified.

CSR Client Status Monitoring

The software running on the CSR's computer, the CSR Client attempts to automatically set the status of the CSR. The CSR may be away from her desk, answering the phone, or working with other, more important applications and may not be able to be “on call” for a user. While the CSR has the ability to set her status manually, the CSR Interface will attempt to automatically set the status of the user.

The CSR Client accepts “configuration information” that helps control the status monitoring. This configuration information may be available to the application as a configuration file or be accepts through a graphical user interface. A sample configuration file is below.

Configuration File

| Name | Value | Options (Not part of file) |
|---|---|---|
| USE_MANUAL_SETTINGS_ONLY | True | True/False |
| MONITOR_KEYBOARD_USAGE | True | True/False |
| MONITOR_MOUSE_USAGE | True | True/False |
| MONITOR_APPLICATION_USAGE | False | True/False |
| APPLICATIONS_MONITORED | watch.exe*try.exe | All Applications being |
| | | monitored delimited with an |
| | | asterisk. |
| POLLING_PERIOD | 45000 | Period of polling to verify |
| | | mouse, keyboard and |
| | | application usage in |
| | | milliseconds. |
| THRESHOLD_IDLE_TIME | 100000 | Idle time (milliseconds) of |
| | | the system before STATUS = |
| | | UNAVAILABLE automatically. |
| ALLOW_OVERRIDING_MANUAL_SETTING | True | True/False |
| STATUS_VERIFICATION_TIME | 50000 | Time in milliseconds |
| | | available for user to refer |
| | | to prompt for STATUS. |
| STATUS_VERIFICATION_INTERVAL | 10000000 | Minimum time in |
| | | milliseconds between 2 |
| | | consecutive status |
| | | verifications. |
| MAXIMUM_SIMULTANEOUS_CHATS | 2 | Maximum number of |
| | | simultaneous chats. |
| MAXIMUM_WORDS_PER_MIN | 200 | Maximum number of words per |
| | | minute. |

USE_MANUAL_SETTINGS_ONLY is a flag that is used to prevent automatic status setting by the CSR Client. This makes it necessary for the CSR to set the STATUS=AVAILABLE or STATUS=UNAVAILABLE manually. USE_MANUAL_SETTINGS_ONLY=TRUE makes the rest of the file redundant since the CSR Client's status will reflect only the settings manually entered by the user.

MONITOR_KEYBOARD_USAGE, MONITOR_MOUSE_USAGE are typically set to true if USE_MANUAL_SETTINGS_ONLY=False. This is because mouse and keyboard activity indicate the presence of a CSR at the computer is likely. It is assumed that the CSR using the computer is available to serve online users.

MONITOR_APPLICATION_USAGE and APPLICATIONS_MONITORED are used to overcome the shortcomings of monitoring only mouse and keyboard usage. While a CSR may be at her desk using her computer it does not necessarily mean that the CSR is available. In reality the CSR could be using other software, such as answering email messages, entering data into a SAP system etc. By specifying MONITOR_APPLICATION_USAGE=true and APPLICATIONS_MONITORED as a list of the applications that are monitored, the system will consider a user of any of the “Monitored Applications” as unavailable. Thus, in a scenario such as a CSR using an SAP reporting system, one may list the SAP executable file in the APPLICATIONS_MONITORED section, thus resulting in STATUS=UNAVAILABLE during the usage of the SAP reporting system despite mouse and keyboard usage..

POLLING_PERIOD is the periodicity of polling to verify mouse, keyboard and application usage in milliseconds.

THRESHOLD_IDLE_TIME is used to evaluate whether there is been no usage of the mouse, keyboard and the monitored applications for a time that exceeds its value. Once the THRESHOLD_IDLE TIME is exceeded, the CSR Interface sets STATUS=UNAVAILABLE.

ALLOW_OVERRIDING_MANUAL_SETTING, is set to True indicates that if the CSR sets the manual setting and the CSR Interface detects a change in status, the status may be set automatically, thus overriding the manual setting. This prevents the occurrence of a CSR setting the system to STATUS=UNAVAILABLE and then forgetting to set STATUS=AVAILABLE. In the event that the ALLOW_OVERRIDING_MANUAL_SETTING=False the user will be prompted to indicate whether the status is set correctly. This process is known as mandatory status verification. If the user does not respond to this within the STATUS_VERIFICATION_TIME, the status is set to unavailable.

STATUS_VERIFICATION_INTERVAL specifies the minimum time between two status verifications to prevent the CSR from being prompted for a valid status too often.

MAXIMUM_SIMULTANEOUS_CHATS defines the maximum number of users a CSR can communicate with. Once the number of simultaneous chats equals MAXIMUM_SIMULTANEOUS_CHATS the number of vacant communication slots for the user is zero.

MAXIMUM_WORDS_PER_MIN defines the number of words per minute beyond which no vacant communication slots are set to zero. This helps achieve more fine-grained control on the evaluation of vacant communication slots.

CSR RATING

On each page being monitored, the Merchant has the ability to include parameters indicating ‘page category’. This parameter, like the ‘page priority’ parameter is associated with the page. When the service offer is made to the customer and the customer responds favorably, the system searches for CSRs skilled in the area of interest of the customer. At the end of a service session, the customer has the option to ‘rate’ the CSR with a scoring of 1-10, with ‘1’ being the highest. Each rating is associated with points, with ‘1’ corresponding to the maximum number of points as defined by the merchant.

Sample Rating-Score Mapping

| Rating | Score |
|---|---|
| 1 | 50 |
| 2 | 40 |
| 3 | 35 |
| . | . |
| . | . |
| . | . |
| 10 | 0 |

This scoring, helps establish the performance of the CSR in relation with a particular page category and correspondingly, customer interest group. For example a CSR may be scored as shown below:

| CSR Name | Janet Tan |
|---|---|
| Categories | Total Skill Scores |
| Home Appliances | 300 |
| Electronics | 500 |
| Travel Gear | 100 |
| Women's Clothing | 200 |
| Total Score | 1100 |

When CSRs first use the system, they specify their skill levels on their own. As customers interact with the system and rate CSRs, the skill levels of the CSRs are altered based on the customer ratings.

The CSRs' scores for each category is a function of the ratings from all the customers as well as the self-rating.

S=Score for the CSR for a particular product category.

CS_{—}1, CS_{—}2, CS_{—}3 . . . =Scores corresponding to ratings given by Customer 1, 2, 3 and so on.

CSRS=Self-rating of CSR.

S=f(CS_{—}1, CS_{—}2, CS_{—}3, . . . CS_N, CSRS)

In one embodiment, S=CS_{—}1+CS_{—}2+CS_{—}3+ . . . CS_N+CSRS. Whenever a user enters a rating, the corresponding ‘score’ is added to the ‘total skill score’ for that category. Individual scores such as CS_{—}1, CS_{—}2 etc. are not stored.

In another embodiment, Merchants also have the ability to include the priority of the rating customer to evaluate the score. This is possible when a Merchant may want to attach more weight to the viewpoint and feedback of a high-priority (a large number of Quality Points associated with the user) user. Therefore, if

C_QP_{—}1, C_QP_{—}2 . . . =Quality Points associated with Customer 1, 2 and so on.

S=f(CS_{—}1, C_QP_{—}1, CS_{—}2, C_QP_{—}2, CS_{—}3, C_QP_{—}3, . . . CS_N, CQP_N, CSRS)

In the preferred embodiment, the score, CS added on for a single user with Quality Points QP associated with him that has assigned the user a rating that corresponds to a ‘raw score’ of RCS will be,

CS=RCS*((ΣQP+QP)/ΣQP)

The equation above demonstrates that the rating associated with a CSR are adjusted based on the Quality Points associated with user giving the rating, such that the CSR score increases for higher values of QP.

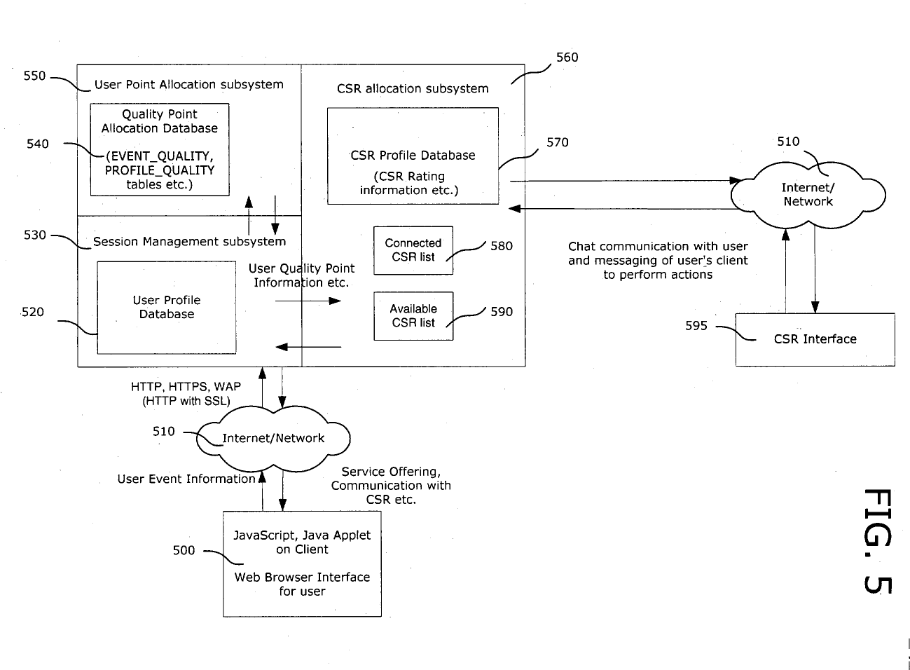

FIG. 5 is the block diagram of the entire system. The user surfs a Web site using a Web browser 500 on his computer or other Internet client. The parameters associated with the user by virtue of his online behavioral patterns along with the “events” that he has triggered during his web surfing experience are sent through the Internet/Network 510 to the Session Management subsystem 530. The Session Management subsystem then obtains historical user information (if available) by referring to the User Profile Database 520 and retrieves the last Quality score associated with the user (if any). After refreshing and updating the value of the Quality Score associated with the user as described in the OBTAINING INITIAL QUALITY POINTS FOR A REPEAT USER section, the User Quality Point Allocation subsystem 550 then further allocates Quality Points to the user based on event and profile information in accordance with the entries in the Quality Point Allocation Database, 540. The CSR Allocation subsystem 560 determines which users are offered service and sales based on CSR availability, skills, points etc. (as stored in the CSR profile database 570) and the Quality Score associated with the users. The CSR Allocation subsystem maintains the state of the CSRs in terms of the Connected CSR list 580 and Available CSR List 590. The CSR Interface 595 is the communication interface that runs on the CSRs computers so that they may communicate with users in real-time.

Types of Composite Events

Composite events may have two attributes, “Order” and “Sequence”. The following are the various types of composite events.

Ordered, continuous composite events are those composite events wherein for a composite event to be completed, a sequence of events need to occur in the same order as listed in the COMPOSITE_EVENT_DESC field in the EVENT_QUALITY table and must not be interrupted by any event that is not part of the composite event. For example, consider a composite event with event name “CE1” and COMPOSITE_EVENT_DESC=E1*E2*E5. Now if and only if E1, E2 and E5 occur continuously for that particular user is the composite event CE1 said to be completed. If events E1, E2, E3, E4 and E5 occur, the presence of E3 and E4 indicates that the composite event was not completed.

Ordered, non-continuous events are those composite events wherein for a composite event to be completed, a sequence of events needs to occur in the same order as listed in the COMPOSITE_EVENT_DESC field in the EVENT_QUALITY table. It is acceptable even if the occurrence of the events is non-continuous. For example, consider a composite event with an event name “CE3” and COMPOSITE_EVENT_DESC=E1*E2*E4. Now if E1, E2, E3, E4 and E5 occur in sequence the composite event CE2 is said to be completed, even though E1, E2 and E4 did not occur in sequence.

Non-ordered, continuous events are those composite events wherein for the composite event to be completed, all the events that occur in the COMPOSITE_EVENT_DESC field in the EVENT_QUALITY table need to occur in any order, but require that they are uninterrupted by events other events. For example, consider a composite event with event name “CE3” and COMPOSITE_EVENT_DESC=E1*E3*E4*E5*E6. Now if E3, E4, E6, E1, E5 occur in the said order, a composite event is said to be completed. If, events E3, E4, E2, E6, E1, E5 occur in the said order, the composite event is not completed because of the event E2 breaking the continuity.

Non-ordered, non-continuous events are those composite events wherein for the composite event to be completed all the events that occur in the COMPOSITE_EVENT_DESC field in the EVENT_QUALITY table need to occur. They order of occurrence and continuity does not matter. For example, consider a composite event with event name “CE4” and COMPOSITE_EVENT_DESC=E1*E3*E4*E5*E6*E7. If the events E3, E4, E2, E10, E6, E1, E5, E7 occur, the event is composite event is completed.

The preferred embodiment purges all pending events at the end of the user session. Other embodiments include storing all the pending events in the user profile database so that when the next session begins, the new events can complete some composite events that were in the process of being completed in the previous session(s) but were not completed.

One with ordinary skill in the art will be able to implement the comparison between the pending event list and the composite event list with the above information.

Levels of Service

It has already been discussed that the Quality Points of different users result in different types of offers of service—some may be a static image “bubble” or some may be an image that floats across the browser window. In another embodiment, the Quality Points mechanism may also define different users having access to different “levels of service”. Users with higher number of quality points may be offered live service through video streaming, while those with lower number of quality points may be offered audio service. Users with an even lower number of Quality Points may be offered text service or be served by “Servabots”.

In a live sample scenario a pool of users may be divided as follows:

| Quality Score Percentile | Type of Service |
|---|---|
| Above 95 | Video |
| 90-95 | Audio |
| 80-89 | Text |
| 50-79 | Servabots |
| 30-49 | On-demand service (user-driven) |
| Below 30 | No Service offer |

And another page break here . . . I don't know if this was supposed to be on a new page because it's a new title . . .

Multiple Site-Wide Service

Call centers, Customer Service and Tele-Marketing companies typically offer their manpower services to multiple companies. If the appropriate event monitoring client-side code (JavaScript and Java Applets) were inserted into the Web sites of their customers, that are in fact Merchants it would give rise to tremendous cross-marketing opportunities. For example, consider a call center with two customers: Merchant A (dealing in sports goods) and Merchant B (dealing in books). If a user triggers a particular event on the Merchant A website like submitting a shopping cart with over ‘x’ dollars worth of sports goods the CSR would potentially have an opportunity to sell and market books that relate to a related book on Merchant B's site. In fact, for one of ordinary skill in the art with the description of the above invention, it will be possible that Quality Points given on Merchant A's site may translate to a certain number of Quality Points on Merchant B's site. This context when extrapolated to many companies will empower CSRs to leverage user information that are shared between an alliance of companies to market products to users on different sites.

Privacy and Intrusive Issues

It is anticipated that some user(s) may not choose to be part of the Quality Point system where they are prioritized. To prevent this from happening users have an opt-out mechanism. By “opting out” a cookie or will be stored on the system or other customer identification techniques will be used that will result in the user being completely ignored by the User Quality Point Allocation subsystem. No event information will be sent to the Session Management subsystem and no quality points will be offered. Some Merchants may choose to have an on-demand customer service offering for such users that are required to “Click for Customer Service” similar to other technologies in the marketplace.

A customer service offering may also appear to be intrusive to some users. It is important that the Merchant carefully decides how prominent the service offering is made. For example, it can be a subtle, small image as against an image floating across the screen playing an audio tune. Intrusiveness is primarily handled by the way the Merchant allocates Quality Points and the way the service offering is made. The invention does not attempt to educate Merchants on how they need to do business, simply because every business operates differently. The Merchant has the freedom to decide on how the invention behaves.

Of course, it should be understood that a wide range of changes and modifications can be made to the preferred embodiments described above. For example, the method and system described herein should not be limited to the Internet. Indeed, the system and method may be implemented on any type of network, including private intranets or semi-permanent cellular or wired networks. Furthermore, one skilled in the art would recognize that a wide variety of software and hardware platforms may be utilized to implement the present invention. It is therefore intended that the foregoing detailed description be regarded as illustrative rather than limiting and that it be understood that it is the following claims, including all equivalents, which are intended to define the scope of this invention.

Real-Time Referral System to Allocate Commissions For CSR(s)

In order that the CSRs are motivated to serve and to sell products to customers, Merchants may choose to enable a dynamic, real-time online customer referral process. Sites like Amazon.com have “Affiliate Programs” and “Referral Programs” for their partners. These programs involve placing a link on a particular partner's site that sells an Amazon product. When a customer purchases the product from the partner's or affiliate's site (or reaches the Amazon.com site from a partner's site), a commission is accordingly disbursed to the referring partner. The current invention goes a step further by enabling special discounts or normal sales offerings to be made dynamically and proactively by a CSR, embedding session information related to that CSR such that when a user completes a transaction, the CSR is automatically associated as a “trigger” for the deal and assigned a commission that may be a fixed amount, percentage or another value.

Mobile Aspect

This invention may be leveraged and extended in a similar manner in the “mobile world” to enable allocation of QUALITY POINTS based on user location and hence the corresponding prioritization of users to include new parameters such as where they are and the direction in which they are heading. A user may then be “approached” by a live CSR or by machine driven voice or text communication.

Conclusion

In the electronic world today, it has not been possible to properly implement the “sales process”. The invention described herein, enables Merchants that do transactions through electronic means to prioritize customers based on business rules and enable an automatic method of real-time market segmentation to identify key users (potential customers) to properly utilize sales resources and to increase sales of high value, high margin products.

What we claim is:

1. A system that enables the allocation of Quality Points (a prioritization mechanism) to users based on their current and historical profiles, actions, events and behavioral patterns on a Merchant's Web site in accordance with business rules set by the Merchant and bases proactive and reactive sales, customer service and resource allocation decisions on this.

2. The system of claim 1 that enables the allocation of resources such as those of sales, customer service, bandwidth and manpower to users by establishing the “Quality of the User” based on the Quality Scores the users are associated with.

3. The system of claim 1 that enables automatic adjustment of historically (previously) acquired Quality Points in accordance with adjustment factors specified by the Merchant in order that the relevance of historically acquired Quality Points be maintained in the current context.

4. The system of claim 1 that enables the specification of Business Rules vis-á-vis the Quality Point Allocation database so as to appropriately identify key users as per the Merchant's specification.

5. The system of claim 1 that enables monitoring and corresponding allocation of Quality Points for simple and composite events as indicated in the Quality Point Allocation database.

6. The system of claim 1 that enables the scaling of Quality Points obtained for events based on the Web page on which the event occurs, thereby not only allowing Merchant's to prioritize users based on their actions, but also based on the segment or location of the website where the actions or events occur.

7. The system of claim 1 that appropriately allocates users to Customer Service Representatives (CSRs) based on their (the CSRs) skills and feedback from previous users.

8. The system of claim 1 that allows Website users to opt-out from the system.

9. The system of claim 1 that enables CSRs to obtain commissions based on the online transactions they play a role in triggering.

10. The system of claim 1 that enables a CSR to allow and enable moderated or unmediated communication between two or more users on the same Web site and correspondingly offering benefits such as commissions, discounts, electronic coupons and gift certificates to users that stimulate product purchases from other users.

11. The system of claim 10 wherein the CSRs role of selection, allocation, moderation of users is automated.
